(19) United States
(12) Patent Application Publication
(10) Pub. No.: US 2015/0208492 A1
(43) Pub. Date: Jul. 23, 2015

(54) END OF LIFE PROTECTION FOR VOLTAGE FED BALLAST

(71) Applicant: General Electric Company, Schenectady, NY (US)

(72) Inventor: Chenghua Zhu, Shanghai (CN)

(21) Appl. No.: 14/421,270

(22) PCT Filed: Aug. 22, 2013
(86) PCT No.: PCT/US2013/056094

§ 371 Date: Feb. 12, 2015

(30) Foreign Application Priority Data
Sep. 28, 2012 (CN) 201210368351.9

(51) Int. Cl. H05B 41/24; H05B 41/36

(52) U.S. Cl. CPC H05B 41/24; H05B 41/36

(57) ABSTRACT

An electric lighting device includes a voltage-fed inverter configured to receive a DC voltage and produce an AC lamp voltage. A lamp load is coupled to the AC lamp voltage and this lamp load includes a gas discharge lamp and a sensing capacitor coupled in series with the gas discharge lamp. A failing gas discharge lamp places a DC bias voltage on the sensing capacitor. A voltage regulator is included that is configured to receive the AC lamp voltage, generate a reference voltage and adjust the inverter frequency to regulate the AC lamp voltage at a generally constant level corresponding to the reference voltage. An EOL protection circuit is included that is configured to receive the DC bias voltage and adjust the reference voltage such that the AC lamp voltage is lowered when a magnitude of the DC bias voltage exceeds a predetermined threshold voltage.

### BACKGROUND

The aspects of the present disclosure relate generally to the field of electric lighting, and in particular to ballast circuits used to drive gas-discharge lamps.

### DESCRIPTION OF RELATED ART

A gas-discharge lamp belongs to a family of electric lighting or light generating devices that generate light by passing an electric current through a gas or vapor within the lamp. Atoms in the vapor absorb energy from the electric current and release the absorbed energy as light. One of the more widely used types of gas-discharge lamps is the fluorescent lamp which is commonly used in office buildings and homes. Fluorescent lamps contain mercury vapor whose atoms emit light in the non-visible low wavelength ultraviolet region. The ultraviolet radiation is absorbed by a phosphor disposed on the interior of the lamp tube causing the phosphor to fluoresce, thereby producing visible light.

Fluorescent lamps exhibit a phenomenon known as negative resistance, which is a condition where increased current flow decreases the electrical resistance of the lamp. If a simple voltage source is used to drive a fluorescent lamp, this negative resistance characteristic leads to an unstable condition in which the lamp current rapidly increases to a level that will destroy the lamp. Thus, a fluorescent lamp needs to be driven from a power source that can control the lamp current. While it is possible to use direct current (DC) to drive a fluorescent lamp, in practice, alternating current (AC) is typically used because it affords better control of the lamp current. The current controlling circuits used to drive fluorescent lamps are generally referred to as ballast circuits or “ballasts”. In practice, the term ballast is commonly used to refer to the entire fluorescent lamp drive circuit, and not just the current limiting portion.

Current flow through a fluorescent lamp is generally achieved by placing cathodes at either end of the lamp tube to inject electrons into a vapor within the lamp. These cathodes are structured as filaments that are coated with an emissive material used to enhance electron injection. The emission mix typically comprises a mixture of barium, strontium, and calcium oxides. A small electric current is passed through the filaments to heat them to a temperature that overcomes the binding potential of the emissive material allowing thermionic emission of electrons to take place. When an electric potential is applied across the lamp, electrons are liberated from the emissive material coating on each filament causing a current to flow. While a lamp is in operation, and especially when a lamp is ignited, the emission mix is slowly sputtered off the filaments by bombardment with electrons and mercury ions. The rate of depletion of the emission mix varies from filament to filament. Thus as a lamp nears its end of life, the emission mix on one filament will deplete more quickly and exhibit lowered electron emissions while the other filament will continue to support normal electron emissions. This can lead to a slight rectification of the alternating current flowing through the lamp. Continued operation of a lamp after the emission mix is depleted can lead to overheating resulting in cracking of the glass allowing hazardous mercury vapor to escape. It is therefore desirable to detect when a lamp is nearing its end of life (EOL) and turn it off before overheating can occur.

Many lamp ballasts in use today are based on a voltage fed topology where the final inverter stage is driven by a voltage source. These voltage-fed topologies are capable of providing an inherent EOL protection function, which can prevent a lamp near EOL from overheating, without extinguishing other non-rectifying lamps that may be powered by the same ballast. The inherent EOL protection topology may be advantageously employed in parallel-connected systems to shut off EOL lamps while continuing to provide power to non-rectifying (non-EOL) lamps, thereby aiding visual identification of a lamp or lamps that need to be replaced. However when energy saving lamps or other types of secondary lamps are used in a ballast designed for regular lamps, the inherent EOL protection does not provide reliable results. This is because the voltage regulator of the voltage fed ballast is typically designed to keep the high frequency bus voltage, which is used to drive the lamps, at a constant level regardless of the type of lamp installed in the ballast. Therefore, these ballasts cannot accommodate certain types of fluorescent lamps, such as newer energy saving lamps, which have lamp voltages that are different than the design voltage of the ballast. Installing newer energy saving lamps, such as a 21-watt or 14-watt lamps, into ballasts of this type can lead to hazardous conditions as the lamps near EOL.

Accordingly, it would be desirable to provide lamp ballasts that address at least some of the problems identified above.

### SUMMARY

As described herein, the exemplary embodiments overcome one or more of the above or other disadvantages known in the art.

One aspect of the present disclosure relates to an electric lighting device. In one embodiment, the electric lighting device includes a voltage-fed inverter configured to receive a DC voltage and produce an AC lamp voltage. A lamp load is coupled to the AC lamp voltage and this lamp load includes a gas discharge lamp and a sensing capacitor coupled in series with the gas discharge lamp. A failing gas discharge lamp places a DC bias voltage on the sensing capacitor. A voltage regulator is included that is configured to receive the AC lamp voltage, generate a reference voltage and adjust the inverter frequency to regulate the AC lamp voltage at a generally constant level corresponding to the reference voltage. An EOL protection circuit is included that is configured to receive the DC bias voltage and adjust the reference voltage such that the AC lamp voltage is lowered when a magnitude of the DC bias voltage exceeds a predetermined threshold voltage.

Another aspect of the exemplary embodiments relates to a ballast circuit or assembly for driving a gas discharge lamp. In one embodiment, the ballast circuit includes a voltage-fed resonant inverter configured to receive a DC input voltage and produce a high frequency AC voltage. The ballast circuit also has a voltage regulator coupled to the inverter that is configured to receive the high frequency AC voltage. The voltage regulator generates a reference voltage and adjusts the inverter frequency so that the high frequency AC voltage is maintained at a generally constant voltage corresponding to the generated reference voltage. A sensing capacitor is coupled in series with the gas discharge lamp. When the gas discharge lamp nears its end-of-life (EOL), a DC bias voltage is placed on the sensing capacitor. An EOL protection circuit is also included that receives the DC bias voltage and adjusts the reference voltage generated by the voltage regulator. The EOL protection circuit adjusts the reference voltage such that the high frequency AC voltage is lowered when the gas discharge lamp nears its end-of-life.

A further aspect of the present disclosure relates to a method for driving one or more gas-discharge lamps. In one embodiment, the method uses a resonant inverter to convert a DC voltage into a regulated AC lamp voltage. The AC lamp voltage is coupled to one or more gas-discharge lamps such that an AC lamp current flows through each of the gas-discharge lamps. The AC lamp current is monitored for current imbalances created by a failing lamp, and a bias voltage imparted on a sensing circuit by the current imbalances is detected. It is then determined if the magnitude of the DC bias voltage exceeds a predetermined threshold magnitude. The AC lamp voltage is reduced when the magnitude of the DC bias voltage exceeds the predetermined threshold magnitude.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the present disclosure, and together with the general description given above and the detailed description given below, serve to explain the principles of the present disclosure. As shown throughout the drawings, like reference numerals designate like or corresponding parts.

FIG. 1 illustrates a block diagram of an electronic lighting apparatus using an AC to DC inverter to generate a high frequency AC voltage to drive one or more gas discharge lamps incorporating aspects of the disclosed embodiments.

FIG. 2 illustrates an exemplary self-oscillating voltage-fed inverter incorporating aspects of the present disclosure.

FIG. 3 illustrates a schematic diagram of an exemplary voltage regulator incorporating aspects of the present disclosure.

FIG. 4 illustrates a schematic diagram of an exemplary EOL protection circuit incorporating aspects of the disclosed embodiments.

FIG. 5 illustrates an exemplary inverter control circuit incorporating aspects of the present disclosure.

FIG. 6 illustrates a flow chart of a method for providing end of life protection for gas discharge lamps incorporating aspects of the present disclosure.

### DETAILED DESCRIPTION OF THE DISCLOSED EMBODIMENTS

Aspects of the present disclosure are directed to electronic lighting and more particularly to ballasts with end-of-life protection for use in connection with fluorescent lamps and will be described with particular reference thereto, although the exemplary ballasts described herein can also be used in other lighting applications and configurations, and are not limited to the aforementioned application. For example, various disclosed advances can be employed in single-lamp ballasts, series-coupled multiple-lamp ballasts, and the like.

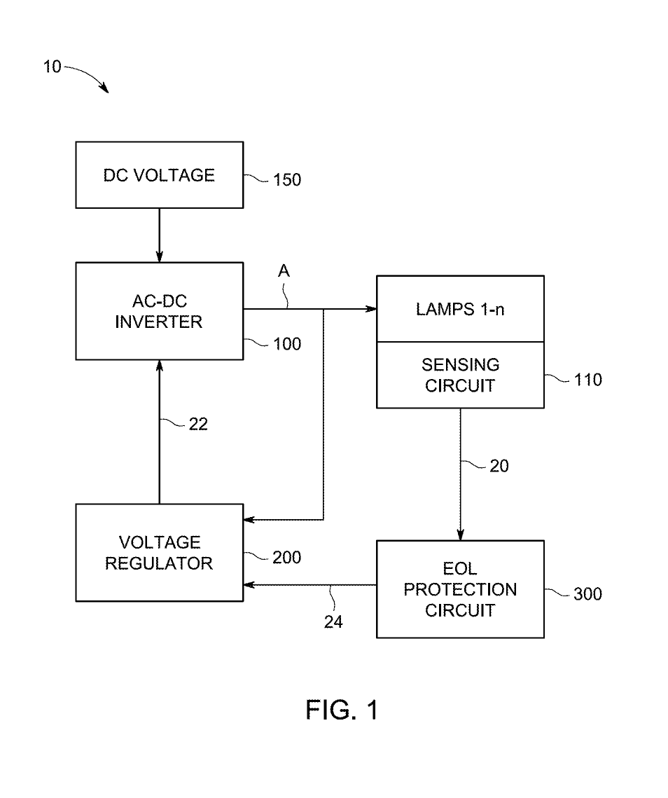

Referring to FIG. 1, a block diagram of a system 10 for providing end-of-life (“EOL”) protection for gas discharge lamps driven by an electronic ballast is illustrated. The electronic lighting apparatus 10 illustrated uses an AC to DC inverter 100 to generate a high frequency AC voltage A to drive one or more gas discharge lamps, generally referred to as lamps 1-n. A DC voltage 150 is received by the inverter 100, which in one embodiment comprises a voltage fed resonant inverter. The DC voltage 150 is converted to a high frequency AC voltage A to drive one or more of the gas discharge lamps, lamps 1-n. For efficient operation of the gas discharge lamps, it is desirable to regulate the high frequency AC voltage A being applied to the lamps 1-n.

In the exemplary embodiment shown in FIG. 1, the electronic lighting apparatus includes a voltage regulator 200 that monitors the high frequency AC voltage A and operates the inverter 100 through control signal 22. Control signal 22 is used to vary the high frequency AC voltage A such that the lamps 1-n, are operated in a safe and efficient manner. When a lamp nears its end-of-life it can overheat and crack, releasing dangerous materials into the atmosphere. To prevent this, an EOL protection circuit 300 is included which is configured to reduce the high frequency AC voltage A when a lamp nears its end-of-life. A sensing circuit 110 is coupled to lamps 1-n and is configured to accumulate a bias voltage 20 when one or more of the lamps 1-n nears its end of life. The bias voltage 20 is provided to the EOL protection circuit 300. When the EOL protection circuit 300 determines that at least one of lamps 1-n is failing, it signals the voltage regulator 200 by lowering the reference voltage 24 used by the voltage regulator 200. The voltage regulator 200 generates the corresponding control signal 22, which is used by the inverter 100 to lower the high frequency AC voltage A.

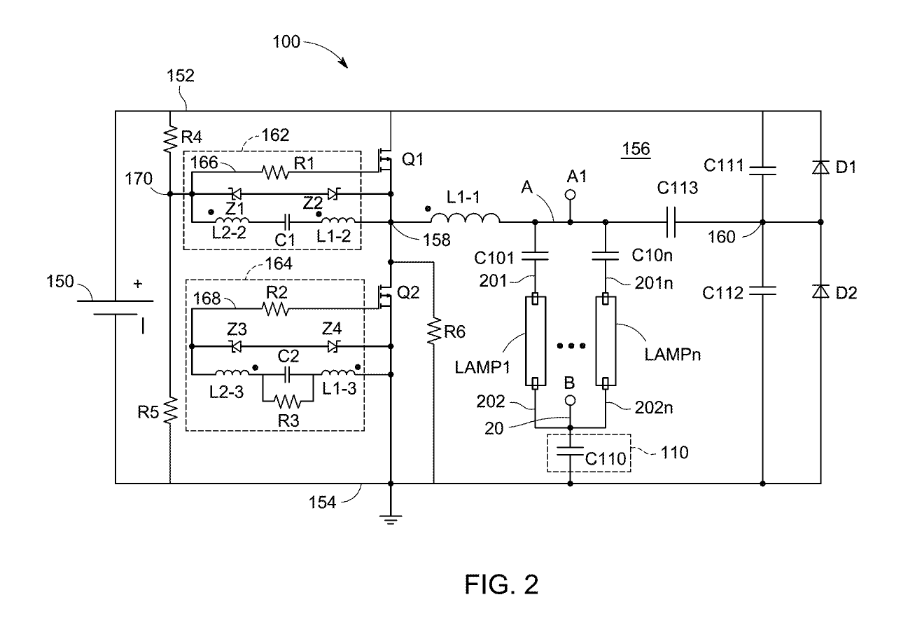

FIG. 2 illustrates one embodiment of an exemplary self-oscillating voltage-fed inverter 100. In the embodiment shown in FIG. 2, the inverter 100 receives a DC input voltage 150 across a positive input rail 152 and ground rail 154. A voltage-fed inverter, such as the exemplary self-oscillating voltage-fed inverter 100 illustrated in FIG. 2, may be advantageously used in various types of ballasts, for example, instant start or program start ballasts. The inverter 100 includes a resonant tank circuit, designated generally by numeral 156, and a pair of controlled switching devices Q1 and Q2. In the embodiment shown in FIG. 2, the switching devices Q1, Q2 are n-type metal oxide semiconductor field effect transistors (MOSFETs), although in alternate embodiments, any suitable controlled switching device may be advantageously employed. The DC input voltage 150 is received by the input and ground rails 152, 154 and is selectively switched by switching devices Q1 and Q2, which are connected in series between the positive input rail 152 and ground rail 154. The selective switching of switching devices Q1 and Q2 operates to generate a square wave at an inverter output node 158, which in turn excites the resonant tank circuit 156 to thereby drive a high frequency AC voltage at node A1. The frequency of the square wave generated at inverter output node 158 is referred to herein as the operating frequency of the inverter 100 or as the frequency of the inverter 100.

In the embodiment shown in FIG. 2, the resonant tank circuit 156 includes a resonant inductor L1-1 and capacitors C111 and C112 connected in series between the positive input rail 152 and the ground rail 154. A center node 160 between the series coupled capacitors C111, C112 is coupled to the high frequency AC voltage A from FIG. 1 at node A1 by capacitor C113. A clamping circuit is formed by diodes D1 and D2, individually connected in parallel with the capacitances C111 and C112, respectively.

The switching devices Q1 and Q2 are alternately activated to provide a square wave output with amplitude of approximately one-half the DC input voltage 150 at the inverter output node 158. This square wave inverter output at the inverter output node 158 excites the resonant tank 156 to produce the high frequency AC voltage A at node A1. The high frequency AC voltage A is used to drive one or more lamps 1-n. As shown in FIG. 2, a first terminal 201-201n corresponding to each of lamps 1-n, is individually connected to node A1 through a series connected ballasting capacitor, referred to as C101 through C10n, respectively. The second terminal 202-202n of each lamp 1-n, is connected together at node B. Node B is coupled to the ground rail 154 through an EOL sensing circuit 110. In the embodiment shown in FIG. 2, the EOL sensing circuit 110 comprises a sensing capacitor C110. In alternate embodiments, any other suitable sensing circuit 110 may be used that is configured to accumulate a bias voltage 20 that indicates an end-of-life condition in any of the lamps 1-n. As will be discussed in more detail below, the EOL sensing circuit 110 provides the bias voltage 20 at node B that indicates an EOL condition of one or more of the lamps 1-n. While the exemplary inverter 100 illustrates the lamps 1-n wired in parallel, a skilled artisan will recognize that alternate lamp configurations such as series connected lamps, a single lamp, or other combination of series and parallel connected lamps may also be advantageously employed.

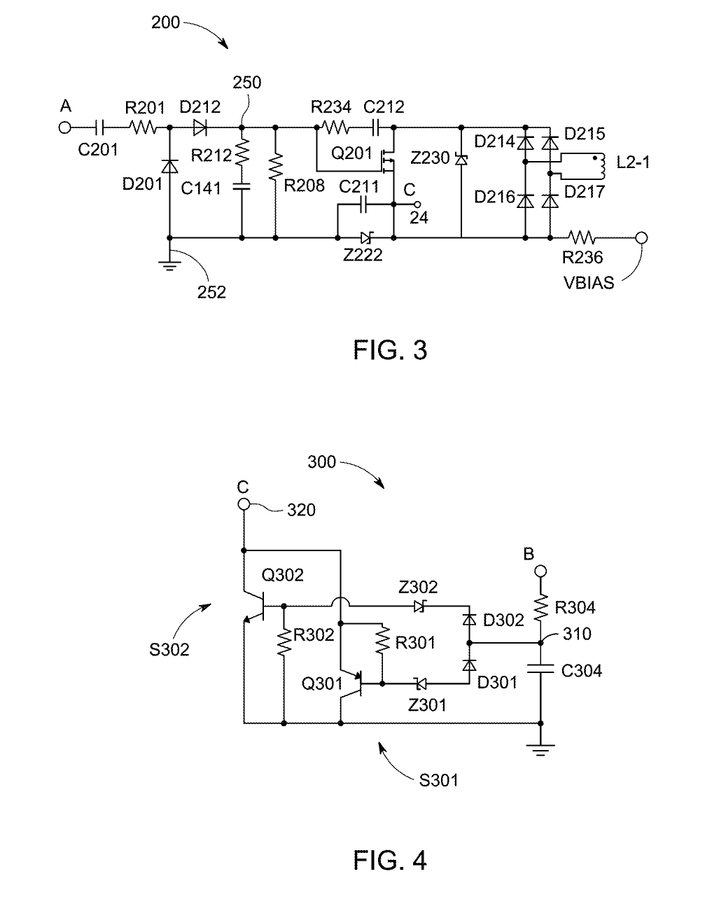

Switching control signals for operating the pair of switching devices Q1, Q2, are provided by a pair of gate drive circuits 162, 164 respectively. Gate or control lines 166 and 168 respectively include resistors R1 and R2 to provide control signals to the control terminals of Q1 and Q2, respectively. The first gate drive circuit 162 is coupled between the inverter output node 158 and a first circuit node 170, and the second drive circuit 164 coupled between the ground rail 154 and the gate control line 168. The first and second gate drive circuits 162, 164 include a first and second driving inductors L1-2 and L1-3 respectively, which are mutually magnetically coupled to the resonant inductor L1-1 of the resonant tank 156 to induce voltage in the first and second driving inductors L1-2, L1-3 that is proportional to the instantaneous rate of change of current in the resonant tank 156 for self-oscillatory operation of the inverter 100. First driving inductor L1-2 is magnetically coupled in reverse polarity from second driving inductor L1-3 to resonate inductor L1-1 to provide alternate switching of Q1 and Q2 to form the square wave at inverter output node 158. In addition, the first and second gate drive circuits 162, 164 include secondary inductors L2-2 and L2-3, respectively, where each secondary inductor L2-2, L2-3 is serially connected through a respective capacitor C1 and C2, to the respective first and second driving inductors L1-2, L1-3 and to their respective gate control lines 166, 168. The secondary inductors, L2-2 and L2-3, are magnetically coupled to a tertiary winding L2-1 located in the exemplary voltage regulator 200 illustrated in FIG. 3. This magnetic coupling between the secondary inductors L2-2, L2-3 and the tertiary winding L2-1 provides the control signal 22 of FIG. 1, which, as will be discussed further below, may be used by the voltage regulator 200 to control a frequency of the square wave at inverter output node 158. The exemplary inverter 100 is designed to have the nominal inverter operating frequency above the resonant frequency of the resonant tank 156 so that reducing the operating frequency of inverter 100 increases the high frequency AC voltage A at node A1, and increasing the operating frequency of the inverter 100 reduces the high frequency AC voltage A at node A1. This allows the high frequency AC voltage A at node A1 to be controlled by varying the inductance of the secondary inductors L2-2, L2-3.

In operation, the first and second gate drive circuits 162, 164 maintain the switching device Q1 in an “ON” state and switching device Q2 in an “OFF” state for a first half of a cycle. The switching device Q2 is in an “ON” state and the switching device Q2 is in an “OFF” state for a second half of the cycle to generate the generally square wave at the inverter output node 158 for excitation of the resonant tank circuit 156. In one embodiment, the gate-to-source voltage of each of the switching devices Q1 and Q2 is limited by bi-directional voltage clamps formed by respective pairs of diodes Z1 and Z2, and Z3 and Z4, shown in this example as back-to-back zener diodes. As is shown in FIG. 2, the first pair of zener diodes Z1, Z2 is coupled between the source of switch Q1 and the gate control line 166. The second pair of zener diodes Z3, Z4 is coupled between the source of switch Q2 and the gate control line 168. In the illustrated embodiment the individual bi-directional voltage clamp formed by zener diode pairs Z1, Z2 and Z3, Z4, respectively, cooperate with their respective secondary inductors L2-2 and L2-3 to control the phase angle between the fundamental frequency component of the voltage across the resonant tank 156 and the AC current in the resonant inductor L1-1.

To start the resonant inverter 100, series connected resistors R4 and R5 across the DC input voltage 150 cooperate with a resistor R6 (coupled between the inverter output node 158 and ground rail 154) to initiate regenerative operation of the gate drive circuits 162, 164. As shown in FIG. 2, the gate drive circuits 162, 164 respectively include capacitors C1 and C2 coupled in series with the secondary inductors L2-2 and L2-3. When DC input power 150 is initially applied to the inverter 100, C1 is charged from the positive DC rail 152 by current flowing through R4, R5, and R6, while resistor R3 shunts capacitor C2 in the second drive circuit 164 to prevent C2 from charging. This prevents concurrent activation of Q1 and Q2. Since the voltage across C1 is initially zero, the series combination of inductors L1-2 and L2-2 acts as a short circuit due to a relatively long time constant for charging of the capacitor C1. Once C1 charges up to the threshold voltage of the gate-to-source voltage of switching device Q1, (e.g., about 2 to 3 volts in one embodiment), switching device Q1 turns “ON” and a small bias current flows through the switching device Q1. In one embodiment, this current biases switching device Q1 to provide sufficient gain to allow the combination of the resonant tank circuit 156 and the first gate drive circuit 162 to produce a regenerative action to begin oscillation of the inverter 100 at or near the resonant frequency of the series resonant network created by capacitor C1, inductance L2-2 and inductance L1-2, which is above the natural resonant frequency of the resonant tank 156. As a result, the resonant voltage seen at the high frequency node A1 lags the fundamental frequency of the inverter 100 and therefore the inverter 100 begins operation in a linear mode at startup and transitions into switching mode once steady state oscillatory operation is established.

In steady state operation of the inverter 100, the square wave voltage at the inverter output node 158 has amplitude of approximately one-half of the DC input voltage 150, and the initial bias voltage across C1 drops. A first series resonant circuit formed by inductance L2-2 and capacitor C1 and a second series resonant network formed by L2-3 and capacitor C2 are equivalently inductive with an operating frequency above the resonant frequency of the first and second series resonant networks. In steady state oscillatory operation, this results in a phase shift of the first gate drive circuit 162 to allow the current flowing through the inductor L1-1 to lag the fundamental frequency of the voltage produced at the inverter output node 158, thus facilitating steady-state soft-switching of the inverter 100. In one embodiment, the output voltage of the inverter 100 at inverter output node 158 is clamped by the serially connected clamping diodes D1 and D2 to limit high voltage seen by the capacitors C111 and C112. As the output voltage of the inverter 100 at node 158 increases, the clamping diodes D1, D2 start to clamp, preventing the voltage across the capacitors C111 and C112 from changing polarity and limiting the output voltage at node 158 to a value that prevents thermal damage to components of the inverter 100.

As one of the lamps 1-n, nears its end-of-life, generally referred to herein as the end-of-life state, the emission mix at a filament of the failing lamp starts to become depleted. When this happens, electron emission from the depleted filament is less than electron emission from the non-depleted filament creating an imbalance between the forward and reverse current flowing through the operable lamps 1-n. This imbalance results in a rectification of the lamp current. Rectification of the lamp current imparts a bias voltage 20 on the sensing circuit 110 that can be used as an EOL signal at node B.

FIG. 3 illustrates one embodiment of an exemplary voltage regulator 200 that may be used to monitor the high frequency AC voltage A at node A1 of FIG. 2. The voltage regulator 200 can adjust the inductance of secondary inductances L2-2 and L2-3 (located in the respective first and second gate drive circuits 162 and 164 of FIG. 2), thereby maintaining the high frequency AC voltage A at a generally constant value. The tertiary winding L2-1 shown in FIG. 3 is magnetically coupled to secondary inductances L2-2 and L2-3 in the gate drive circuits 162, 164 of inverter 100, such that varying loading on the tertiary winding L2-1 produces corresponding variations in inductances provided by the secondary inductances L2-2, L2-3. The exemplary voltage regulator 200 operates to maintain the high frequency AC voltage A at a generally constant value in accordance with a reference voltage at node C shown in FIG. 3. The voltage regulator 200 senses the high frequency AC voltage A at node A1 via resistor 8201 capacitively coupled to the node A1 by capacitor C201. A pair of diodes D201, D212 provides rectification of the filtered AC voltage across 8201, which is further filtered by the parallel combination of resistor R212 and capacitor C141 connected in series, and resistor 8208, connected between the rectified voltage at node 250 and circuit ground 252, thus providing a feedback voltage at node 250 to control a gate of switching device Q201, which in one embodiment comprises an n-channel enhancement MOSFET. The switching device Q201 controls the loading of the tertiary winding L2-1 through four diodes D214, D215, D216, and D217 to set the frequency of the inverter 100, in effect, increasing or decreasing the loading on winding L2-1 to increase or decrease the high frequency AC voltage A at node A1. A zener diode Z230 is used to clamp the voltage at drain of Q201 relative to circuit node 252. A bias voltage Vbias is provided to generate the reference voltage 24 at node C by another zener diode Z222 through resistor 8236, which clamps the source of Q201 to the reference voltage at node C. A capacitor C211 provides filtering and stabilizes the reference voltage 24 at node C. The resistor R234 and capacitor C212 are connected in series between the gate control line 250 and the drain of Q201 and establish a negative feedback control for operation of the voltage regulator 200. A higher bus voltage at node A1 will cause Q201 to increase the loading on L2-1 thereby increasing the inverter frequency to a lower AC bus voltage A at node A1. The high frequency AC voltage A at node A1 will be maintained at a generally constant value.

In the illustrated inverter 100 of FIG. 2, as the operating frequency decreases, the voltage of the high frequency AC voltage A increases, and vice versa. Further, the operating frequency of the inverter 100 decreases with decreased loading of the tertiary winding L2-1. Thus, the voltage regulator 200 increases or decreases the loading on tertiary winding L2-1 to reduce or raise the voltage produced at the high frequency AC voltage A, respectively. Through this action the exemplary voltage regulator 200 of FIG. 3 maintains the high frequency AC voltage A at node A at a generally constant value corresponding to the reference voltage 24 at node C.

When one or more of the lamps 1-n of FIG. 2 nears end-of-life, there will be a positive or negative DC bias voltage 20 applied on the sensing capacitor C110. This bias voltage 20 can be detected and used as an EOL signal. The EOL signal can be used to drop the reference voltage 24 at node C in FIG. 3, to a lower level or to zero using an EOL protection circuit such as the exemplary EOL protection circuit 300 illustrated in FIG. 4 and described in detail below.

When the reference voltage 24 at node C is lowered, the high frequency AC voltage at node A will also be decreased by the voltage regulator 200 as described above, which will reduce the current through, or extinguish the lamp 1-n, that is nearing end-of-life. This can prevent overheating of the lamp that is nearing end-of-life while maintaining sufficient power to the remaining lamps to keep them in a lighted state. Lowering of the reference voltage 24 can be accomplished in a variety of ways. In one embodiment, an EOL protection circuit 300, such as that shown in FIG. 4, is used to couple node C of FIG. 3 to circuit ground 252. The EOL protection circuit 300 is configured to conduct current when an EOL signal, i.e. a non-zero DC bias voltage on the capacitor C110, is detected, thereby lowering the reference voltage 24 at node C, which in turn lowers the high frequency AC voltage A at node A1.

FIG. 4 illustrates one embodiment of an exemplary EOL protection circuit 300 that may be used to lower the reference voltage 24 at node C used by the voltage regulator 200 to regulate the high frequency AC voltage A at node A1. In this example, an output node 320 of the EOL protection circuit 300 is electrically coupled to the reference voltage 24 at node C of the voltage regulator 200. Node B shown in FIG. 2 is electrically coupled to node B of FIG. 4, and the EOL protection circuit 300 receives the EOL signal at node B. In one embodiment, the EOL protection circuit 300 uses a filter network formed by series connected resistor R304 and capacitor C304 to remove AC components from the EOL signal at node B, which as discussed above is derived from the DC bias voltage 20 imparted on the sensing circuit 110 by one of the lamps 1-n that is nearing its EOL. A filtered EOL signal is produced at a central circuit node 310 located between the series connected resistor R304 and capacitor C304. The EOL protection circuit 300 includes two complementary switching circuits S301, S302. The first switching network S301 is formed from a diode D301, zener diode Z301, resistor R301, and switching device or transistor Q301. The second switching circuit S302 is formed from a diode D302, zener diode Z302, resistor R302, and switching device or transistor Q302. When a lamp 1-n nears its end-of-life, it will place an EOL signal that contains either a positive DC voltage or a negative DC voltage on the sensing circuit 110, depending on which lamp filament begins to fail first. When the filtered EOL signal at node 310 is a negative voltage, the first switching circuit S301 operates while D302 prevents current from flowing from the second switching circuit, S302.

In one embodiment of the exemplary EOL protection circuit 300, the switching devices or transistors Q301 and Q302 in each of the switching circuits S301 and S302 comprise bipolar junction transistors (BJTs). In alternate embodiments, any other suitable type of switching devices may be employed, other than including bipolar junction transistors, such as for example, metal oxide semiconductor field effect transistors (MOSFETs). The zener diode Z301 is used to set a threshold voltage for detection of an EOL condition. Once the filtered EOL signal at node 310 exceeds the breakdown voltage of the zener diode Z301, an EOL condition is present and current begins to flow through resistor R301, thereby applying a base-to-emitter voltage to the switching device Q301 resulting in current being conducted through the switching device Q301 which lowers the reference voltage 24 at node C of FIG. 3, which is coupled to output node C at output node 320.

Similarly, when the filtered EOL signal at node 310 is a positive voltage, diode D301 prevents current from flowing in the first switching circuit S301, while zener diode Z302 sets a threshold voltage in the second switching circuit S302. Once the voltage of the filtered EOL signal at node 310 exceeds the breakdown voltage of zener diode Z302, the second switching device Q302 begins to conduct, lowering the reference voltage 24 at node C of FIG. 3, which is coupled to output node 320 of FIG. 4. Thus, the exemplary EOL protection circuit 300 will lower the reference voltage 24 whenever the magnitude of the filtered EOL signal at node 310 exceeds a predetermined threshold voltage, in either a positive or negative direction. The EOL protection circuit 300 has the advantage that is can be easily micronized, which means it can be made smaller and less costly than other EOL protection schemes.

In the above embodiment, the EOL protection circuit 300 has its output node 320 coupled to the reference voltage at node C of the voltage regulator 200, and is used to lower the reference voltage 24 whenever an EOL condition is detected at node B. Alternatively, the EOL protection circuit 300 may be used to lower the voltage at other nodes of the exemplary voltage regulator 200 to achieve a similar effect of lowering the high frequency AC voltage A at node A1 when an EOL condition is detected at node B. For example, by coupling the output node 320 of the EOL protection circuit 300 to the cathode of zener diode Z230, or by coupling the output node 320 of the EOL protection circuit 300 to the bias voltage input node Vbias of the exemplary voltage regulator 200 shown in FIG. 3, the voltage regulator 200 may be caused to regulate the high frequency AC voltage A at node A1 at a lower level.

In certain embodiments, it is advantageous to shut down the inverter 100 when an EOL condition is detected. When an inverter is shut down, its switching action is stopped and the output voltage, i.e. the high frequency AC voltage A at node A1, is reduced to about zero volts. An exemplary embodiment of a technique for shutting down the inverter 100 will be now be illustrated. In one embodiment, the inverter 100 can be shut down when an EOL condition is detected for example by coupling the output node 320 of the EOL protection circuit 300 in FIG. 4 to node 170 of the first gate drive circuit 162 coupled to the switching device Q2 of the inverter 100 shown in FIG. 2. In this configuration, when an EOL condition is detected at node B by the EOL protection circuit 300 of FIG. 4, the voltage at the gate of switching device Q2 is pulled to ground by the EOL protection circuit 300, thereby stopping oscillation of the inverter 100 and shutting the inverter 100 down.

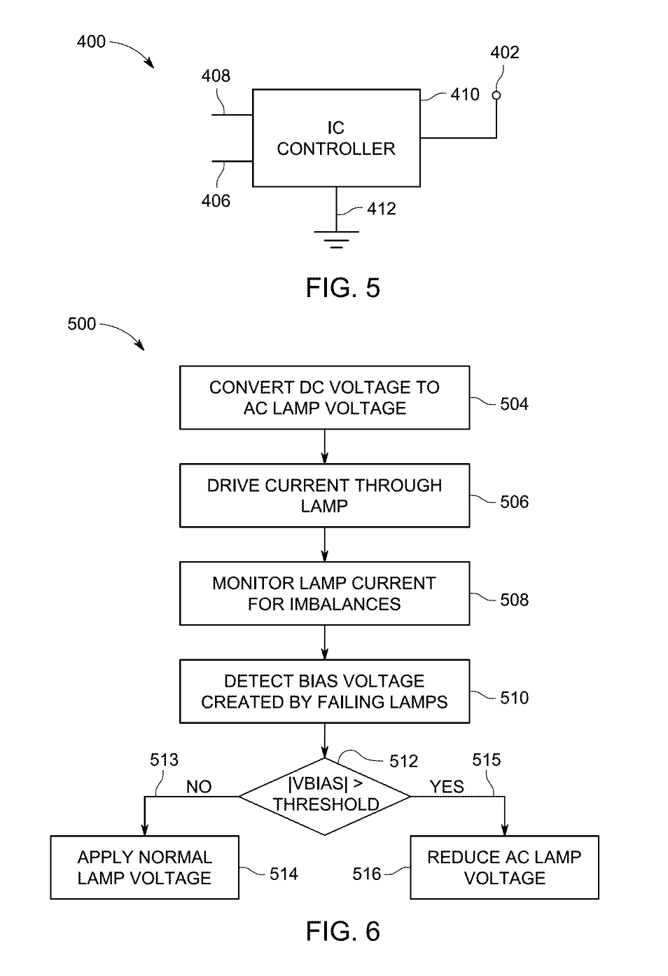

In self-oscillating voltage-fed inverters, such as the inverter 100 illustrated in FIG. 2, a magnetically coupled voltage regulator, such as the voltage regulator 200 illustrated in FIG. 3 may be used to regulate the high frequency AC voltage A at node A1 at a generally constant level in accordance with the reference voltage 24 at node C. Alternatively, in other voltage-fed resonant inverter topologies, the high frequency AC voltage A at node A1 may be regulated using an integrated circuit, such as integrated circuit 400 illustrated in FIG. 5. In this embodiment, the integrated circuit (IC) controller 410 receives an operating voltage, such as a common collector voltage VCC, at node 402 and provides gate drive signals 406, 408 that may be coupled directly to the gate terminals of the switching devices Q1 and Q2 (of the inverter 100 illustrated in FIG. 2) in place of the first and second gate drive circuits 162, 164. Node 412 of integrated circuit controller 410 is coupled to ground. By coupling the output node 320 of the EOL protection circuit 300 to the common collector supply voltage input 402 of the integrated circuit 410, the inverter 100 can be shut down when an EOL condition is detected.

FIG. 6 illustrates a flow chart of an exemplary method 500 for providing end of life protection in a ballast for gas discharge lamps. In one embodiment, a DC voltage is converted 504 to an AC lamp voltage using a voltage-fed resonant inverter. In certain embodiments, a voltage-fed self-oscillating inverter such as the inverter 100 illustrated in FIG. 2 may be used to receive a DC voltage 150 and create a high frequency AC voltage. One or more gas discharge lamps are coupled to the AC lamp voltage and a lamp current is driven 506 through the lamps in order to maintain each of the lamps in a normal operation state. A sensing circuit, such as sensing circuit 110 of FIG. 2, is coupled in series with the lamp current and used to monitor the lamp current for imbalances 508. When a gas discharge lamp, such as a fluorescent lamp, is operating normally, the current flowing during both half cycles of the AC lamp voltage is nearly the same. When a lamp nears its end of life, it begins to rectify the lamp current and the current flowing in one direction is less than the current flowing in the other direction.

In one embodiment, the bias voltage Vbias that the rectified lamp current imparts on the series connected sensing circuit 110 is detected 510. Depending on which filaments begin to deplete first, the bias voltage Vbias can have either a positive or a negative polarity. In either case, the positive or negative magnitude of the bias voltage Vbias can be compared 512 to a predetermined threshold voltage to determine if an EOL condition exists on any of the gas discharge lamps. In the exemplary embodiment of FIG. 6, the absolute value of the magnitude of the bias voltage, |Vbias|, is compared 512 to a predetermined threshold. In some embodiments the comparison 512 may be done using a pair of complementary switching devices, such as the pair of switching devices Q301, Q302 in the exemplary EOL protection circuit 300 illustrated in FIG. 4. In this example, one switching device Q302 is activated when the bias voltage Vbias is a positive voltage, and the second switching device Q301 is activated when the bias voltage Vbias is a negative voltage. In the exemplary EOL protection circuit 300, the comparison 512 is made by the zener diodes Z301 and Z302 in combination with the switching devices Q301, Q302. The respective diode Z301, Z302 begins to conduct when the bias voltage Vbias applied to node B of the EOL protection circuit 300 exceeds the breakdown voltage of the respective zener diodes Z301, Z302.

If the comparison 512 indicates that that the absolute value |Vbias| of the bias voltage Vbias is not greater than or below 513 the predetermined threshold voltage, no EOL condition exists and the normal operating AC lamp voltage is applied 514. If the comparison 512 indicates that the absolute value |Vbias| is above or greater than 515 the predetermined threshold, it is determined that an EOL condition exists on the gas discharge lamp and the operating AC lamp voltage is lowered or reduced 516 to a level that will protect the failing lamps from damage. The level or magnitude of the lowered AC lamp voltage level is chosen so that if any of the lamps have been replaced with lower voltage energy efficient lamps, they will also be protected from damage.

Thus, while there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit and scope of the invention. Moreover, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An electric lighting device, the device comprising:
an inverter circuit configured to convert a DC voltage into an AC lamp voltage;
a lamp load coupled to the AC lamp voltage, the lamp load comprising a gas discharge lamp and a sensing circuit, the sensing circuit being coupled in series with the gas discharge lamp and configured to detect a DC bias voltage generated by a gas discharge lamp in an end-of-life state;
a voltage regulator coupled to the AC lamp voltage and configured to generate a reference voltage, the reference voltage being used to maintain a frequency of the inverter at a substantially constant level; and
an EOL protection circuit coupled to the sensing circuit and configured to lower the reference voltage when a magnitude of the DC bias voltage exceeds a predetermined threshold voltage.

2. The electric lighting device of claim 1, wherein the gas discharge lamp comprises a plurality of gas discharge lamps connected in parallel.

3. The electric lighting device of claim 1, wherein the gas discharge lamp comprises a plurality of gas discharge lamps connected in series.

4. The electric lighting device of claim 1, wherein the inverter is a self-oscillating resonant inverter comprising a first and second gate drive circuit, and wherein the voltage regulator is magnetically coupled to each of the first and second gate drive circuits.

5. The electric lighting device of claim 1, wherein the EOL protection circuit comprises a first and a second switching circuit, the first switching circuit being configured to lower the reference voltage when the DC bias voltage comprises a positive DC voltage.

6. The electric lighting device of claim 5, the second switching circuit being configured to lower the reference voltage when the DC bias voltage comprises a negative DC voltage, wherein lowering the reference voltage lowers the AC lamp voltage.

7. A ballast assembly for driving a gas discharge lamp, the ballast assembly comprising:
an inverter configured to convert a DC voltage into high frequency AC lamp voltage to drive the gas discharge lamp;
a voltage regulator coupled to the inverter and configured to generate a reference voltage, the voltage regulator being configured to adjust a frequency of the inverter to maintain the high frequency AC lamp voltage at a generally constant voltage;
an EOL sensing circuit coupled in series with the gas discharge lamp, the EOL sensing circuit configured to detect a DC bias voltage generated by the gas discharge lamp when the gas-discharge lamp is in an end-of-life state; and
an EOL protection circuit configured to detect the DC bias voltage and lower the high frequency AC lamp voltage when the gas discharge lamp is in the end-of-life state.

8. The ballast circuit of claim 7, wherein the inverter is a voltage-fed self-oscillating resonant inverter, the inverter comprising a first and second gate drive circuit, and wherein the voltage regulator is magnetically coupled to each of the first and second gate drive circuits.

9. The ballast of claim 8, wherein the EOL protection circuit is configured to adjust the reference voltage when a magnitude of the bias voltage exceeds a predetermined threshold voltage.

10. The ballast of claim 9, wherein the EOL protection circuit comprises a first and a second switching circuit, the first switching circuit being configured to lower the reference voltage when the DC bias voltage comprises a positive DC voltage.

11. The ballast of claim 10, the second switching circuit being configured to lower the reference voltage when the DC bias voltage comprises a negative DC voltage, wherein lowering the reference voltage lowers the AC lamp voltage.

12. The ballast circuit of claim 10, wherein the first and second switching circuit each comprise at least one of a bipolar junction transistor and a field effect transistor.

13. The ballast circuit of claim 10, wherein the reference voltage is generated at a central node between two serially connected zener diodes, and wherein the EOL protection circuit is coupled to the central node.

14. The ballast circuit of claim 10, wherein the reference voltage is generated at a central node between a first and a second serially connected zener diodes and wherein the EOL protection circuit is coupled to the cathode of the second zener diode, and wherein the anode of the first zener diode is coupled to a circuit ground.

15. The ballast circuit of claim 7, wherein the gas discharge lamp comprises a plurality of gas discharge lamps and the plurality of gas discharge lamps are connected in parallel.

16. The ballast circuit of claim 7, wherein the gas discharge lamp comprises a plurality of gas discharge lamps and the plurality of gas discharge lamps are connected in series.

17. The ballast circuit of claim 8, wherein the voltage-fed self-oscillating resonant inverter comprises a first and second switching device, and wherein the EOL protection circuit is coupled to the second switching device such that the EOL protection circuit shuts down the inverter when a magnitude of the DC bias voltage exceeds a predetermined threshold voltage.

18. The ballast circuit of claim 7, wherein the voltage-fed inverter comprises an integrated circuit configured to receive an operating voltage and to operate the inverter, and wherein the EOL protection circuit is configured to lower the operating voltage such that the inverter is shut down.

19. A method for driving one or more gas-discharge lamps using a resonant inverter to convert a DC voltage into a regulated AC lamp voltage, the method comprising:
converting a DC voltage into a regulated AC lamp voltage;
driving the one or more gas-discharge lamps with the AC lamp voltage such that an AC lamp current flows through each of the one or more gas-discharge lamps;
monitoring the AC lamp current for imbalances created by a failing lamp;
detecting a bias voltage imparted on a sensing circuit by the current imbalances;
determining if a magnitude of the bias voltage exceeds a predetermined threshold; and
reducing the AC lamp voltage when the magnitude of the bias voltage exceeds the predetermined threshold.

20. The method of claim 19, wherein determining if the magnitude of the bias voltage exceeds the predetermined threshold comprises using a first switching device configured to conduct when the bias voltage comprises a positive voltage and a second switching device configured to conduct when the bias voltage comprises a negative voltage.
